(19) United States
(12) Patent Application Publication
(10) Pub. No.: US 2012/0075960 A1
(43) Pub. Date: Mar. 29, 2012

(54) Time Display Device and Method of Displaying Time

(76) Inventor: Baiying Sun, Mississauga (CA)

(21) Appl. No.: 13/245,567

(22) Filed: Sep. 26, 2011

(30) Foreign Application Priority Data
Sep. 25, 2010 (CN) 201010290353.1

(51) Int. Cl. G04B 19/22

(52) U.S. Cl. 368/21

(57) ABSTRACT

A time display device and a method of displaying time in both 12-hour and 24-hour systems and in any time zones are disclosed. The time display device includes a first time display component which may include a 12-hour system circular member, a second time display component which may include a 24-hour system circular member, and a time zone display member. The time display device also includes a time indication component which may include at least an hour hand for indicating the hour of a time on both 12-hour and 24-hour circular members. The hour hand and the time zone display member advance at a speed of one complete turn every 12 hours. The 24-hour circular member advances at half of the speed of the hour hand. Time zone markings on the time zone display member indicate time in different time zones as shown on the 24-hour circular member.

### FIELD OF INVENTION

The invention relates generally to the field of time display devices such as clocks and watches and methods of displaying time.

### BACKGROUND OF INVENTION

It has been quite common for many years for a digital watch or clock to include world time function. It has also been known for even longer to include world time function for an analog watch or clock. Often, an analog watch or clock is more desirable than a digital counterpart because of its decorative as well as ornamental properties, its perceived high collection value and its practicality, which gives its place in both luxury and mass markets.

Most well known coaxial analog world time display devices can be classified into 3 types, i.e. a 12-hour time system, a 24-hour time system and a dual (12-hour and 24-hour) time system with concentric assembly. World time display devices adopting the dual time system appear to be most popular.

One design of a known dual time system watch uses a small central dial and the associated hour pointer and minute pointer for indicating local time. An outer ring is provided for indicating different time zones in the world using different time zone symbols (e.g., names of countries or cities). These symbols are fixedly printed on and around the outer ring. An inner ring, rotating at a speed of completing one circle in 24 hours, is provided to indicate time of different time zones in the world.

This design provides the convenience of displaying local time and world time on the same side of the watch, and thus overcomes the inconvenience of earlier designs caused by showing local time and world time on different sides of a watch. However, displaying of local time and displaying of world time are independent of each other. The two sets of hour symbols on the clock/watch face are not integrated and lack any apparent relationship to a casual user. Thus, it may require one to become familiar with the features of the display system in order to use effectively such a watch or clock, especially when searching for hour reading in a target time zone other than the local time zone. The hour hand of such a design also may not necessarily indicate the local time in a 24-hour system, other than during some brief period. One also would have to read local time twice, once for the local time displayed in the 12-hour system and once for the local time displayed in the 24-hour system.

It is an object of the present invention to mitigate or obviate at least one of the above mentioned disadvantages.

### SUMMARY OF INVENTION

In one aspect of the invention, there is provided a time display device. The time display device includes a first time display component for showing first time markings of a system having a first number of hours in a day on a first time scale, a second time display component for showing second time markings of a system having a second number of hours in a day on a second time scale, a time zone display component including a time zone display, the time zone display including time zone markings to indicate time zones in a pre-defined time zone system such as international time zone system, the total number of whole hour time zones in the pre-defined system being the same as the second number of hours, and a time indication component for positioning a time indicator to indicate time on the first time scale according to a time source. The time indicator and the time zone display of the time display device advance relative to the first time scale both at a first speed and in the same direction, and the second time scale advances relative to the first time scale at a second speed and in the same direction as the time indicator. The second speed and the first speed forms a ratio that is equal to a ratio of the first number of hours to the second number of hours. The second time scale is resettable to align any one of the second time markings with any one of the first time markings at a time reset time and the time zone display is resettable to align any one of the time zone marking with any one of the second time markings of the second time scale at a time zone reset time.

According to one feature of this aspect of the invention, the first time display component is configured according to a 12-hour system and the second time display component is configured according to a 24-hour system.

Optionally, there are less time zone markings than the total number of whole hour time zones; or alternatively, the time zone markings may include at least one marking to indicate region falling within a half-hour or quarter-hour time zone.

According to another feature, the first time display component includes a 12-hour circular member for displaying the first time scale that has indicated thereon the first time markings representing each of 12 hours in a 12-hour system and the second time display component includes a 24-hour circular member for displaying the second time scale that has indicated thereon the second time markings representing each of 24 hours in a 24-hour system; the 12-hour circular member and the 24-hour circular member are concentric.

Further, the time display device may include its own time source, which may be one of mechanical movement, electrical quartz movement, and electronic clock circuitry. The time source may include an energy storage unit for storing energy required for energizing the time source.

According to another feature, the time indicator, the second time scale and the time zone display all advance relative to the first time scale in a clockwise direction or all advance in a counterclockwise direction.

According to another feature, the time display device further includes a display screen to display the first time scale, the second time scale, the time zone display and the time indicator on the display screen. The time display device may further include a microprocessor to control operation of the first time display component, the second time display component, the time zone display component, and the time indication component.

In another aspect of the invention, there is provided a method of displaying time. The method includes the steps of initializing a display area that includes a first time display scale for showing first time markings of a system having a first number of hours in a day, a second time display scale for showing second time markings of a system having a second number of hours in a day, and a time zone display scale for showing time zone markings to indicate time zones in a pre-defined time zone system, the total number of whole hour time zones in the pre-defined time zone system being the same as the second number of hours; obtaining a first time that includes at least a first hour value; positioning a time indicator on the first time display scale according to the first hour value; aligning the second time display scale with the first time display scale according to the first hour value; aligning the time zone display scale with the second time display scale according to the first hour value and an input of a local time zone value, and in a loop until interrupted by an external instruction,
obtaining an updated time;
advancing the hour indicator on the first time display scale according to the updated time, the advancement establishing a first amount advanced by the hour indicator;
advancing the time zone display scale for the first amount;
advancing the second time display scale for a second amount, the second amount being equal to the first amount multiplied by the ratio of the first number of hours to the second number of hours; and
returning to the step of obtaining updated time.

According to a feature of this aspect of the invention, the method includes the additional step of waiting for a first pre-selected period of time prior to returning to the step of obtaining updated time; or alternatively, includes the additional steps of testing between the step of obtaining the current time and advancing the hour indicator if a second pre-selected period of time has elapsed and returning to the step of obtaining updated time if the second pre-selected period of time has not elapsed.

According to another feature of this aspect of the invention, the first time display scale is configured according to a 12-hour system and the second time display scale is configured according to a 24-hour system.

Optionally, the number of time zone markings shown on the time zone display scale is less than the number of time zones. The time zone markings shown on the time zone display scale may include at least one marking to indicate a half-hour or quarter-hour time zone.

According to another feature of this aspect of the invention, the first time display scale includes a 12-hour circular member that has indicated thereon marks representing each hour in a 12-hour system and the second time display scale has a 24-hour circular member that has indicated thereon marks representing each hour in a 24-hour system. The 12-hour circular member and the 24-hour circular member are concentric.

In another aspect of the invention, there is provided a non-transitory computer readable storage medium containing computer program instructions stored thereon. When executed by a processing system, the instructions cause the processing system to perform a method comprising steps of initializing a display area that includes a first time display scale for showing first time markings of a system having a first number of hours in a day, a second time display scale for showing second time markings of a system having a second number of hours in a day, and a time zone display scale for showing time zone markings to indicate time zones in a pre-defined time zone system, the number of time zones in the pre-defined time zone system being the same as the second number of hours; obtaining a first time that includes at least a first hour value; positioning a time indicator on the first time display scale according to the first hour value; aligning the second time display scale with the first time display scale according to the first hour value; aligning the time zone display scale with the second time display scale according to the first hour value and an input of a local time zone value, and in a loop until interrupted by an external instruction,
obtaining an updated time;
advancing the hour indicator on the first time display scale according to the updated time, the advancement establishing a first amount advanced by the hour indicator;
advancing the time zone display scale for the first amount;
advancing the second time display scale for a second amount, the second amount being equal to the first amount multiplied by the ratio of the first number of hours to the second number of hours; and
returning to the step of obtaining updated time.

According to a feature of this aspect of the invention, the first time display scale is configured according to a 12-hour system and the second time display scale is configured according to a 24-hour system.

Optionally, the number of time zone markings shown on the time zone display scale is less than the number of time zones. The time zone markings shown on the time zone display scale may include at least one marking to indicate a half-hour or quarter-hour time zone.

According to another feature of this aspect of the invention, the first time display scale includes a 12-hour circular member that has indicated thereon marks representing each hour in a 12-hour system and the second time display scale has a 24-hour circular member that has indicated thereon marks representing each hour in a 24-hour system. The 12-hour circular member and the 24-hour circular member are concentric.

In other aspects the invention provides various combinations and subsets of the aspects described above.

### BRIEF DESCRIPTION OF DRAWINGS

For the purposes of description, but not of limitation, examples are explained in greater detail by way of examples with reference to the accompanying drawings, in which:

FIG. 1 is a block diagram illustrating components of a time display device according to an example of the present invention;

FIG. 2 shows an example of displaying time using the time display device illustrated in FIG. 1 using a mechanical construction;

FIG. 3 shows an example of displaying time using the time display device illustrated in FIG. 1 using an electronic construction;

FIG. 4 shows steps of a method of displaying time using the time display device shown in FIG. 1;

FIG. 5 shows in a perspective view components of a gear transmission mechanism for an analog world time clock;

FIG. 6 shows an example of a time zone dial;

FIG. 7 shows an example of a 24-hour dial;

FIG. 8 shows in a perspective view an example of a wheel tube;

FIG. 9 shows in a perspective view an example of a ratchet gear;

FIGS. 10-a and 10-b show in perspective views an example of a pawl wheel;

FIG. 11 shows in a perspective view an example of a half-speed wheel tube;

FIGS. 12-a and 12-b show in perspective views an example of an end cover;

FIG. 13 show in a perspective view a composite clock movement in an assembled state for a world time clock of FIG. 5;

FIG. 14 is a sectional view taken along the line A-A in FIG. 13;

FIGS. 15-a, 15-b and 15-c illustrate some examples of movements of clock hands, time zone dial and 24-hour dial relative to the 12-hour dial;

FIGS. 16-a, 16-b and 16-c illustrate some examples of time zone dials;

FIG. 17 illustrates an example of a 24-hour dial;

FIG. 18 illustrates an example of simplified display mechanism;

FIG. 19 illustrates an example of displaying time in the time zone of London;

FIG. 20 illustrates an example of displaying another time in the time zone of London;

FIG. 21 illustrates an example of displaying yet another time in the time zone of London;

FIG. 22 illustrates an example of displaying yet another time in the time zone of London;

FIG. 23 illustrates an example of displaying yet another time in the time zone of London;

FIG. 24 illustrates an example of displaying yet another time in the time zone of London;

FIG. 25 illustrates an example of displaying yet another time in the time zone of London;

FIG. 26 illustrates an example of displaying yet another time in the time zone of London;

FIG. 27 illustrates an example of displaying yet another time in the time zone of London; and

FIG. 28 illustrates an example of displaying yet another time in the time zone of London.

### DETAILED DESCRIPTION OF EXAMPLES

The description which follows, and the examples described therein, are provided by way of illustration of an example, or examples, of particular examples of the principles of the present invention. These examples are provided for the purposes of explanation, and not limitation, of those principles and of the invention. In the description which follows, like parts are marked throughout the specification and the drawings with the same respective reference numerals.

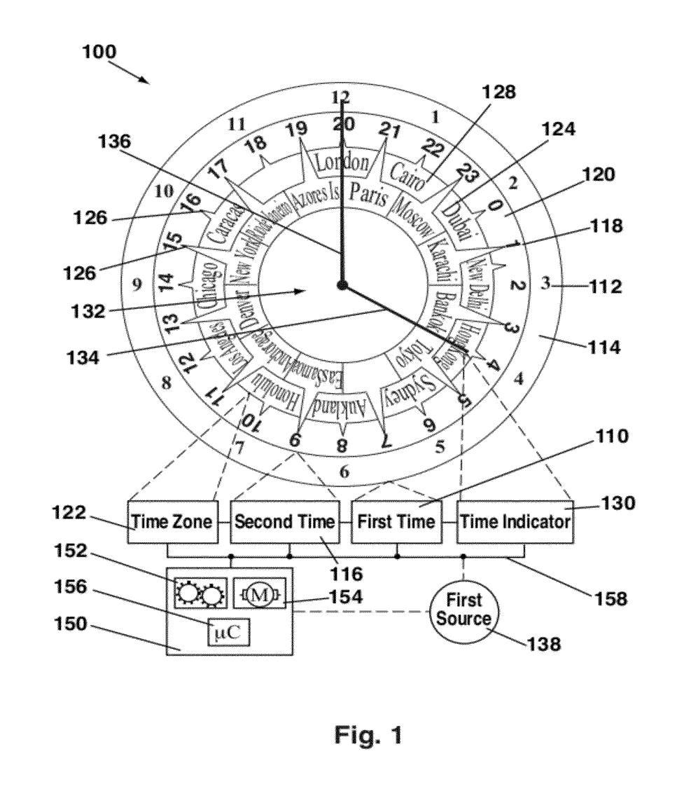

Referring to FIG. 1, there is illustrated in block diagram a time display device 100 according to an example of the present invention.

The time display device 100 has a first time display component 110 for showing first time markings 112 on a first time scale 114, such as 12 markings for each hour in a 12-hour system, and a second time display component 116 for showing second time markings 118 on a second time scale 120, such as 24 markings for each hour in a 24-hour system. In addition, the time display device 100 has a time zone display component 122 for showing a time zone display 124, with time zone markings 126 to represent time zones corresponding to, for example, time zones in a standard international time zone system which is a 24-hour system. The time zone display may additionally provide a label or geographic symbol 128 to indicate the region or city represented by the time zone marking 126.

Also provided is a time indication component 130 for positioning a time indicator 132 to indicate time on the first time scale 114. The time indicator 132 may be an hour hand 134, an hour hand 134 and a minutes hand 136, or an hour hand, a minutes hand and a seconds hand, among others. The time indicator 132 indicates time on the first time scale 114 according to a time source 138. As illustrated in FIG. 1, the second time scale 120 and the time zone display 124 are adjacent to the first time scale 114. Thus, the time indicator 132 can also indicate time on the second time scale 120 and time in different time zones, if the second time scale 120 and the time zone display 124 are properly aligned and advanced in relation to the first time scale 114 as will be described in detail below.

The time display device 100 may include a casing 140. The time source 138 may be located within the casing and may be, for example, a mechanical movement, an electrical quartz movement, or an electronic clock circuitry commonly found in a computer or computing device, among others. The time source 138 may locate outside the casing. For example, the time source may be remote to the time display device, thus providing time information in a remote manner, such as through a communication network, an electric power line, a wired or wireless connection, among others.

The time source 138 may include its own energy storage unit for storing energy required for energizing the time source. The energy storage unit may be a battery for an electric quartz movement or electronic clock circuitry or a spring rewinding mechanism for a mechanical movement.

Typically, a first number of first time markings are used to show each hour in a system that has the first number of hours in a day, a second number of second time markings are used to show each hour in a system that has the second number of hours in a day and the number of time zones may conveniently be the same as the second number, thus using the second number of time zone markings to indicate each time zone. However, this may not be necessary. For example, some of the first time markings or second time markings may be omitted, for space or aesthetical considerations. In addition, while conventionally, each time zone corresponds to the difference of a whole hour, thus the total number of whole hour time zones is equal to the number of hours in a day, there may be provided less time zone markings than the total number of whole hour time zones. For example, some time zones may not have a corresponding marking on the time zone display, due to space, aesthetical or practical considerations.

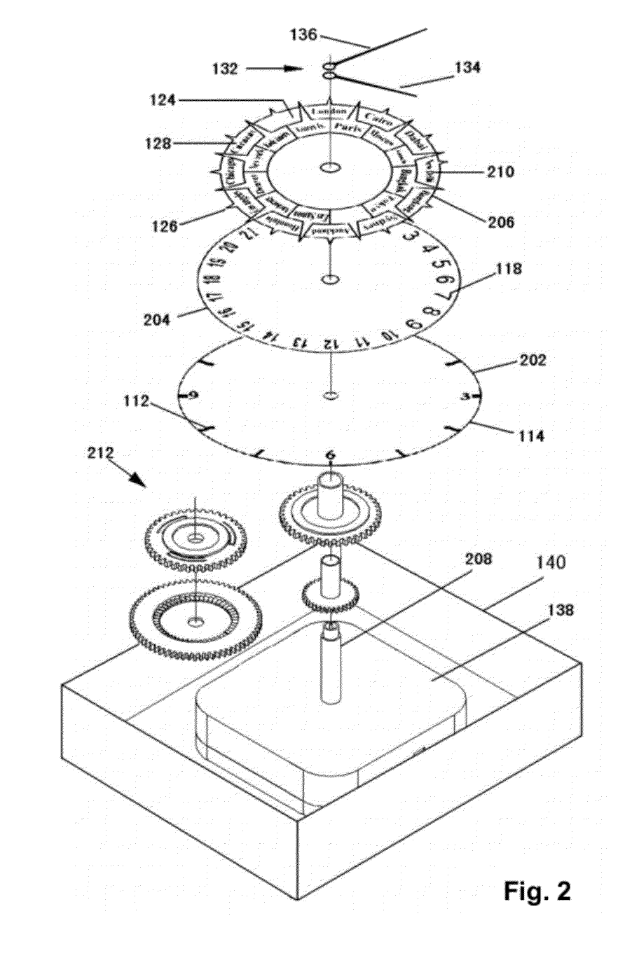

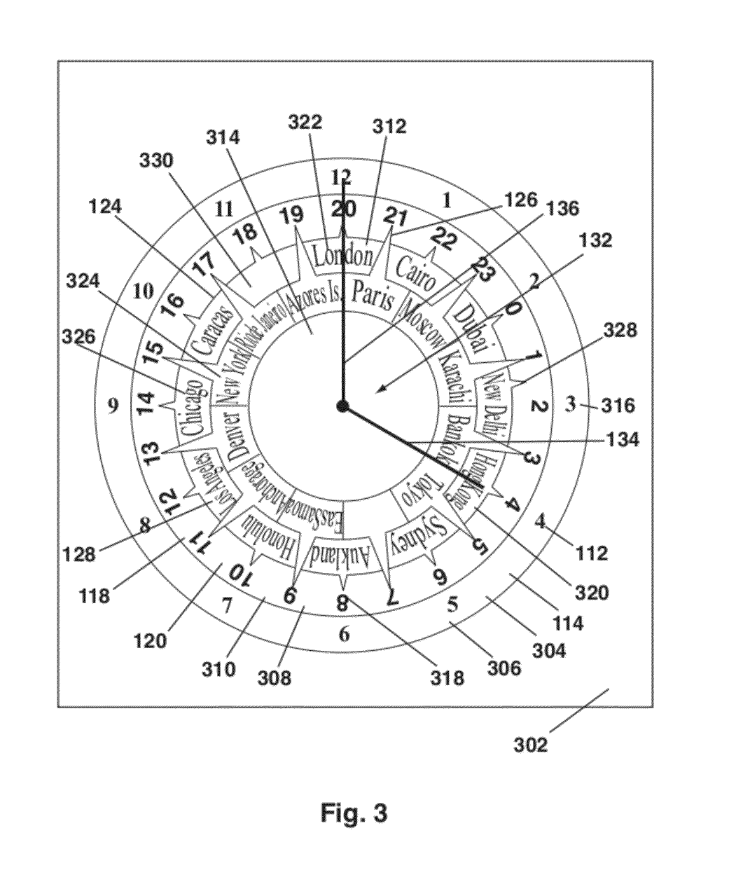

Referring to FIGS. 2 and 3, there are illustrated two examples of a first time scale, a second time scale, a time zone display and a time indicator provided by first time display component, a second time display component, a time zone display component and a time indicator component.

FIG. 2 illustrates a mechanical construction. Referring to FIG. 2, there are shown three separate dials 202,204,206 that are circular and concentric about an hour axis 208. Each dial has circumferential markings to represent hours in a 12-hour system, hours in a 24-hour system and time zones corresponding to the 24-hour system, as will be explained below. They are spaced from each other and appropriately sized to permit simultaneous reading of the markings on all three dials.

Referring to FIG. 2, there is shown a first circular member 202, or more particularly a conventional circular clock or watch dial to show the first time scale 114, with a set of 12 first markings 112 thereon to indicate each hour of the 12 hours in the 12-hour system. Unlike a conventional clock or watch, there is also a second circular member 204, i.e., a second circular dial to show the second time scale, with a set of 24 second markings 118 thereon to indicate each hour of the 24 hours in the 24-hour system. There is in addition a third circular member 206, i.e., a time zone dial 206 to show the time zone display 124. The time zone dial 206 is a toothed circle. Conveniently, there are 24 teeth, i.e., 24 time zone markings 126 corresponding to the 24 hours in the 24-hour system. Each marking has a label or geographic symbol 128 to indicate the time zone represented. For a typical world time clock or watch, these teeth evenly divide the circle into 24 zones, though one may also position one or more markings to indicate regions with half-hour or quarter hour differences, such as New Delhi 210. Conveniently, the time zone labels may be arranged in two rows, or two concentric bands, so that a geographic symbol 128 or label may fit within the space allocated to the time zone.

The second dial, i.e., the 24-hour dial 204, has a diameter smaller than that of the first, i.e., 12-hour dial 202. The third dial, i.e., the time zone dial 206, has a diameter smaller than that of the 24-hour dial 204. This will enable simultaneous unobstructed reading of markings on all three dials when they are in an installed position, in which the 12-hour dial 202 is located at the bottom, the time zone dial 206 is located at the top, and the 24-hour dial 204 is sandwiched between the time zone dial and the 12-hour dial. It will be appreciated that these dials may have other relative sizes and relative locations, provided that they are appropriately sized so that when they are in an installed position and positioned on top of each other, a simultaneous unobstructed reading of markings on all three dials is possible.

When assembled, these three dials are spaced along and concentric about an hour axis 208 and enclosed within a casing 140. An hour hand 134 may be fixedly mounted to hour axis 208 to indicate time on both the 12-hour dial and the time zone dial. As will be appreciated, the hour hand may be replaced by any other suitable time indicator device, such as a moving graphic shape, a moving dot, or a moving light projection illuminating a section or a spot on the dials. The 24-hour dial may also be driven by a half-speed advance mechanism connected to a time source, driven directly by a motor, controlled directly by a controller in the second time display component or connected to and passively driven the first time display component. The similar modifications to direct mounting of time zone dial to hour axis 208 may also be made.

The 12-hour dial 202 is not movable relative to casing 140. The time zone dial 206 is rotated by the hour axis 208 at the same rate of rotation and in the same direction as the hour axis 208. The time zone dial 206 may be directly driven by the hour axis 208 or coupled to and driven by the hour axis 208 to rotate at the same rate as the hour axis 208. The 24-hour dial 204 is also rotated by the hour axis 208 in the same direction but at half the rate of rotation of the hour axis 208, through a half-speed advance mechanism 212 coupled to the hour axis 208, in the nature of a transmission train, for example, a gear train. Alternatively, the 24-hour dial 204 and the time zone dial 206 may also be independently advanced, e.g., by independent motor(s) or gear train driven by motor(s) controlled by a microprocessor or coupled to a time source.

FIG. 3 illustrates an electronic construction of a first time scale 114, a second time scale 120 and a time zone display 124 (including those utilizing a computer or a microprocessor) presented on a display screen 302. These time scales and time zone display are circular in shape and have markings to represent hours in a 12-hour system, hours in a 24-hour system and time zones corresponding to the 24-hour system in a way similar to the mechanical construction shown in FIG. 2, as will be explained below.

As illustrated in FIG. 3, there is a first display region 304 that shows a first time scale 114. In this case, the first display region is a circular ring 306, and the first time scale includes first time markings 112 to show each of 12 hours in a 12-hour system. There is also a second display region 308 that shows a second time scale 120. In this case, the second display region 308 is also a circular ring with markings to show each hour of 24 hours in a 24-hour system. The 12-hour ring 306 and the 24-hour ring 310 are concentric but have different diameters, thus enabling an hour hand 134 to indicate an hour reading in both 12-hour system and 24-hour system. Finally, there is also a third display region 312 that shows a time zone display 124. In this case, the third display region is a time zone circle 314 located inside both the 12-hour ring 306 and the 24-hour ring 310 and concentric with the 12-hour and the 24-hour rings. The time zone display 124 includes time zone markings 126 to indicate time zones.

Again, as will be appreciated, although the time zone circle 314 is shown to locate within both rings, any one of the first time scale 114, the second time scale 120 and the time zone display 124 may be a ring (or all may be rings) and their sizes may have any relative order. Thus, it is also possible to arrange them as three concentric rings, such that the time zone display is an outer ring, the second time scale for displaying 24-hour system time is an inner ring and the first time scale for displaying 12-hour system time is a middle ring sandwiched between the outer and inner rings.

As with the mechanical construction, the 12-hour ring 306 has a set of first time or hour markings to indicate hours in the 12-hour system. In the example illustrated, there are 12 first hour markings, with each marking indicating one of the 12 hours on the first time scale. Conventionally, the markings represent hours increasing in a clockwise direction, though they may also decrease in a clockwise direction for special purpose time display devices, in which case the time zone markings also may be modified accordingly. The 24-hour ring 310 has second time or hour markings to indicate hours in the 24-hour system. In the example illustrated, there are 24 markings, each indicating one of the 24 hours on the second time scale. The time zone circle 314 has time zone markings 126 to indicate time zones corresponding to the 24-hour system illustrated on the 24-hour ring. The number of time zone markings 126 may be the same as the number of hour markings on the second, i.e., 24-hour time scale. These time zone markings divide the time zone display 124 into 24 display zones 320, each corresponding to one of the hours on the second time scale. For clarity, these time zone markings 126 may be arranged in two rows or two concentric bands. Each display zone 320 in the time zone display, or selected display zones 320, may also include a geographic symbol 128, to help users easily identify or locate a time zone on the display.

The display screen 302 may be a display screen of a computing device, such as a desktop or portable computer, a smart phone, a tablet, or a dedicated screen such as a display screen of an electronic watch or clock. With modification, this display may also be projected to a display surface, using an image projecting device, such as a projector or a dedicated projecting device included with the time display device.

Referring to both FIGS. 2 and 3, a time indicator 132 is provided to indicate a time reading. In the mechanical construction shown in FIG. 2, this may be an hour hand 134. In the electronic construction shown in FIG. 3, this may be a graphical representation of an hour hand 134 that is periodically advanced, or it may be any other indicator such as a colored dot placed next to an hour marking to indicate the hour. For a more refined time reading, minutes hand 136 and seconds hand (not shown), or their graphical representation for an electronic construction, may also be provided. While the minutes hand and the seconds hand indicate the same minutes and seconds readings in either of the 12-hour system and the 24-hour system and in any of the time zones, the hour hand 134 provides a reading in both the 12-hour system and the 24-hour system according to the present invention. Hour reading in different time zones is provided by a combination of time zone markings 126 and 24-hour markings 318. For example, FIG. 3 shows a local time of 4 o'clock which is, based on the 24-hour marking 318, 4 o'clock in the early morning. The local time zone in this case is Hong Kong, as indicated by the hour hand 134. The corresponding local time of London is 20:00, as indicated on the 24-hour time scale 310 by the time zone marking for London 322 and the corresponding local time of New York is 15:00, as indicated on the 24-hour time scale 310 by the time zone marking for New York 324.

As described earlier, there may be more or less time zone markings than the total number of whole hour time zones or the hours on the second, i.e., 24-hour scale. One may add one or more markings to indicate half time zones. One may also omit time zone markings for space, aesthetic or practical considerations, thus using time zone markings or geographic symbols only for a few selected time zones that are of interest to a particular group of users. FIG. 3 shows examples of both. A time zone marking for a half time zone 328 is provided to indicate the time zone of New Delhi. On the other hand, geographic symbols are omitted 330 for the time zone between London and Caracas.

It is generally desirable to show local 24-hour time and 12-hour time. Both the 24-hour ring/dial, i.e., the second time scale, and the time zone display circle/dial, i.e., the time zone display, are resettable. To reset the 24-hour ring/dial at any given time, a user aligns one of the second time markings 118, i.e., the 24-hour markings 318 on the 24-hour scale 310 corresponding to the current time, with one of the first set of markings, i.e., the 12-hour markings 316 on the 12-hour scale 306 corresponding to the current time. To reset the time zone ring/dial at any given time, a user aligns the time zone marking 126 corresponding to the local time zone with the current hour marking on the 12-hour time scale 306, which is also aligned with the current hour marking on the 24-hour time scale 310. When the user desires to reset the time display device to a different local time zone, for example, when the user has arrived in Chicago from Hong Kong, the user will need to realign the hour hand 134 with local time, realign the 24-hour mark 318 with the 12-hour mark 316 so the hour hand indicates correctly the hour in both 12-hour and 24-hour systems, and realign the local time zone mark representing Chicago 326 with the current local time.

In order to correctly display time in both 12-hour and 24-hour systems and in different time zones, both the 24-hour ring/dial and the time zone display circle/dial are advanced relative to the 12-hour ring/dial according to a fixed relationship. Conveniently and also according to general convention (although not strictly necessary), the 12-hour ring/dial is held static relative to a casing or the displace screen. In the following, this relationship will be explained assuming the 12-hour ring/dial is held static.

Referring to FIGS. 1 to 3, the hour hand 134 is selected to indicate time in the 12-hour system and therefore advances in the clockwise direction at a first speed, namely, completing a circle in precisely 12 hours. The time zone display 124 or the time zone dial 206 advances at the same first speed relative to the first time scale 114, namely the 12-hour ring/dial, and in the same clockwise direction. The second time scale 120, namely the 24-hour ring/dial, is advanced relative to the 12-hour dial 202 in the same clockwise direction as the hour hand 134 but at a second speed. The ratio of the second speed to the first speed is 1:2, i.e., at half of the first speed. More generally, this ratio equals the ratio of the first number of hours marked on the first time scale (12 in this example) to the second number of hours marked on the second time scale (24 in this example).

Returning to FIG. 1. A driving mechanism 150 is provided to advance the time indicator 132, the time zone ring/dial and the 24-hour ring/dial. This driving mechanism may be mechanical 152, in the nature of a transmission mechanism or gear trains, for example; this may also be electrical 154, in the nature of a motor or motors, for example; this may also be electronic 156, in the nature of a electronic circuitry, a microcontroller or a programmed computer, among others. They may also be mixed, for example, combining a motor with mechanical means, such as gear trains, or combining electronic circuitry with motors.

When a driving mechanism 150 is provided, the operations of the first time display component 110, the second time display component 116, the time zone display component 122, and the time indication component 130 are driven and controlled by the driving mechanism. For example, a conventional clock/watch movement and additional transmissions and gear trains may be provided as a driving mechanism to advance the hour, minutes and seconds hands, and to advance the second time scale, such as a 24-hour system circular plate, and the time zone display, such as a time zone plate, relative to the first time scale, such as a 12-hour system circular plate. Conventionally, the first time display component provides a first time scale that is static relative to a casing 140 or a display screen 302.

As will be appreciated, an electrical quartz movement 154, including motor(s), may be provided to similarly advance the hour, minutes and seconds hands, and to advance the 24-hour circular plate and the time zone plate relative to the 12-hour circular plate for showing time in both 12-hour system and 24-hour system and for showing time in different time zones.

Similarly, when a microprocessor 156 is employed, it may be used to control the first time display component to present on a display screen a first time scale in the nature of a 12-hour display, the second time display component to present a second time scale in the nature of a 24-hour display, and the time zone display component a time zone display, replicating the effects of the circular plates of an electrical/mechanical device. The microprocessor 156 can periodically instruct the first time display component, the second time display component, the time zone component and the time indication component to update their respective displays, thus showing on the display screen 302 the time in both 12-hour and 24-hour systems and in different time zones.

It will be further appreciated that the driving mechanism 150 may be designed to drive each of the individual components 110,116,122,130, or the driving mechanism may be designed to drive one or some of these individual components 110,116,122,130 directly and use couplings or connections between these components to drive the remaining components. For example, for a mechanical system, the driving mechanism may drive directly the time indicator component 130, or more particularly the hour hand 134 and use mechanical connections or couplings in the nature of engaged gears to drive the 24-hour dial 204 and the time zone dial 206, as explained in a further example later. The connection lines 158 indicating in a non-exhaustive manner these possible couplings or connections.

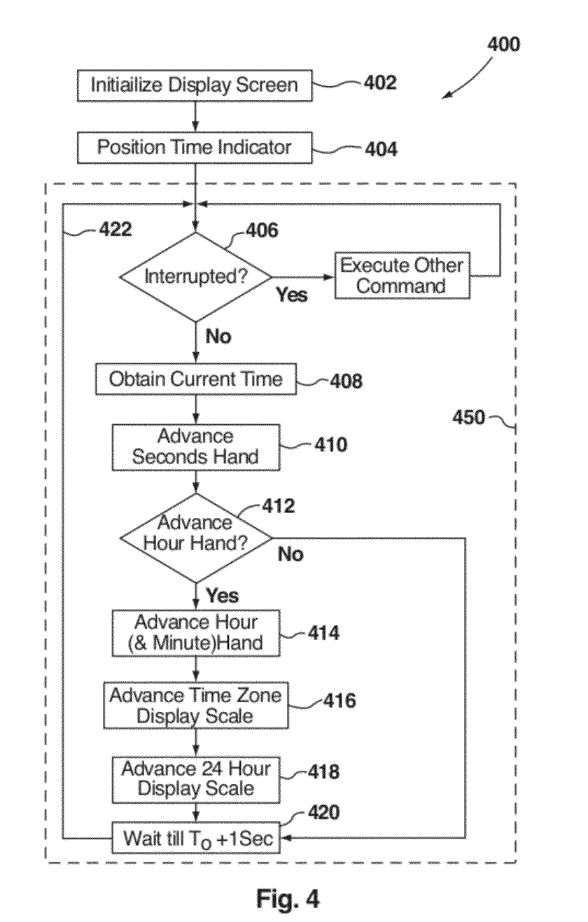

Referring to FIG. 4, there is shown steps of a method 400 of displaying and updating time displayed on a display screen 302. This will be explained in connection with the display shown in and described in connection with FIG. 3. The process may be appropriately implemented electronically. For example, the process may be implemented on a computer or any other computing device that includes a programmable processor. Alternatively, the process may be implemented on a dedicated processor housed in an electronic watch. The processor is programmed according to the process 400 illustrated in FIG. 4.

First (step 402), the display screen 302 is initialized (see FIG. 3) This includes the steps of instructing the first time display component 110 to provide a first time display scale, namely the 12-hour ring 306; instructing the second time display component 116 to provide a second time display scale, namely the 24-hour ring 310, with the 24-hour ring aligned with the 12-hour ring according to local time provided by a time source 138; and instructing the time zone display component 122 to provide a time zone circle 314, with the time zone marking 126 of local time zone aligned with the mark of current hour reading on the 12-hour ring 306. Next (step 404), the time indication component 130 is instructed to position the time indicator 132 to indicate the time obtained from the time source 138 on the first time scale 114. The time value may contain an hour value, a minutes value and a seconds value. Conventionally, an hour hand 134 is provided to indicate the hour value, the minutes hand 136 to indicate the minutes value and the seconds hand to indicate the seconds value.

Next, the time indicator 132, the 24-hour ring 310 and the time zone circle 314 are advanced periodically according to time obtained from the time source 138. This is performed in a loop 450 until an interrupting event happens, for example when a user requests realigning the 24-hour ring or the time zone circle. In this loop, the processor is instructed to first obtain the current time (step 408). Conventionally, the seconds hand is advanced every second. The processor is instructed by the time indicator component, i.e., programmed by it, to calculate the new position of the seconds hand and advance the display of the seconds hand to the new position (step 410). The minutes hand is advanced every minute, or at any other suitable, possibly shorter, interval. The hour hand may be advanced proportionally every minute, or at any other suitable, possibly shorter, interval. A frequency of advancing both the hour and the minutes hands every minute will be used in this example. For every minute, or every 60 seconds, the hour hand is advanced proportionally. The processor tests at step 412 if the pre-determined amount of time has elapsed and therefore should advance the hour or minutes hand. To advance the hour hand (step 414), the processor calculates and advances the hour and minutes hands to their respective new position as instructed or programmed by the time indicator component. This establishes an amount of advancement of the hour hand for each update, which is 360°/(12×60), or 0.5°. Similarly, the processor 156 is programmed or instructed by the time zone display component to advance the display of the time zone circle (step 416) and programmed or instructed by the second time display component to advance the 24-hour ring (step 418). The time zone circle 314 is advanced by the displacement amount, i.e., at the same speed as the hour hand 134. The 24-hour ring 310, on the other hand, is advanced only half the angular displacement amount as the hour hand, i.e., at a second speed that is half of the hour hand's speed. After a predetermined amount of time has elapsed (step 420) since the step of obtaining current time (step 408) of the loop, such as 1 second, the process 400 returns (step 422) to the beginning of the loop and starts the next cycle at step 406. For the other 59 seconds or cycles, i.e., if the hour and minutes hand are not to be advanced, the process jumps directly to the end of the loop to wait (step 420) to return to the top of the loop 450.

As will be appreciated, while a processor may be pre-programmed, for example, when the processor is a dedicated processor, in general, a software program stored on a computer readable storage media is used for loading by a processor in a computer or computing device to program the processor. When the software program is loaded and executed by the processor, the process implemented by the software program will be executed by the programmed computer, or the processor. The computer readable media may be any suitable media and may take different forms as the computer technology evolves. Some examples include an optical storage medium, a magnetic storage medium, or a solid-state memory storage device. However, a processor may also be programmed using firmware, or combinations of firmware and software, among others. The process illustrated in FIG. 4 may be a computer implemented process, and may take the form of a computer software product stored on a computer readable storage media. The computer software product contains computer instructions, which when executed by a computing device, cause the computing device to execute the process illustrated in FIG. 4.

It will be appreciated from the above discussions that various modifications may be made and different time displays, advance mechanisms, time sources and energy units may be combined. It is therefore understood that the time display device according to the present invention (and similarly the method of displaying time) is not limited to any particular examples provided herein. The following there examples are provided to illustrate how these different components may be combined.

### Example 1

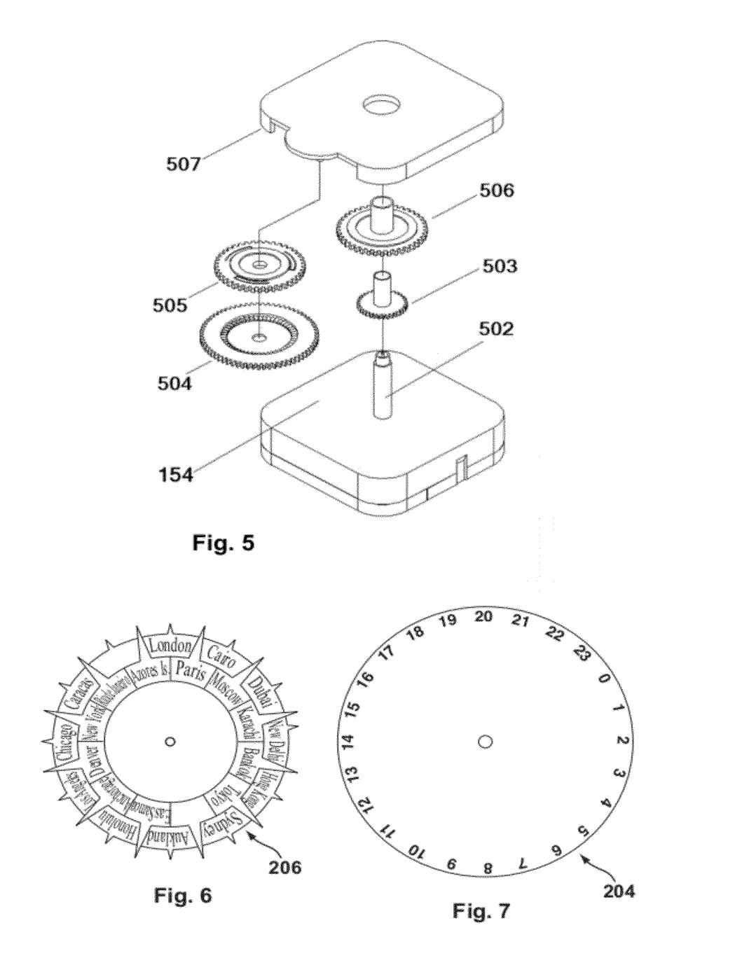

Example 1 provides an analog world time clock adopting a dual-time system. As shown in FIG. 5 to FIG. 15, the analog world time clock adopting the dual-time system is constructed according to the following way.

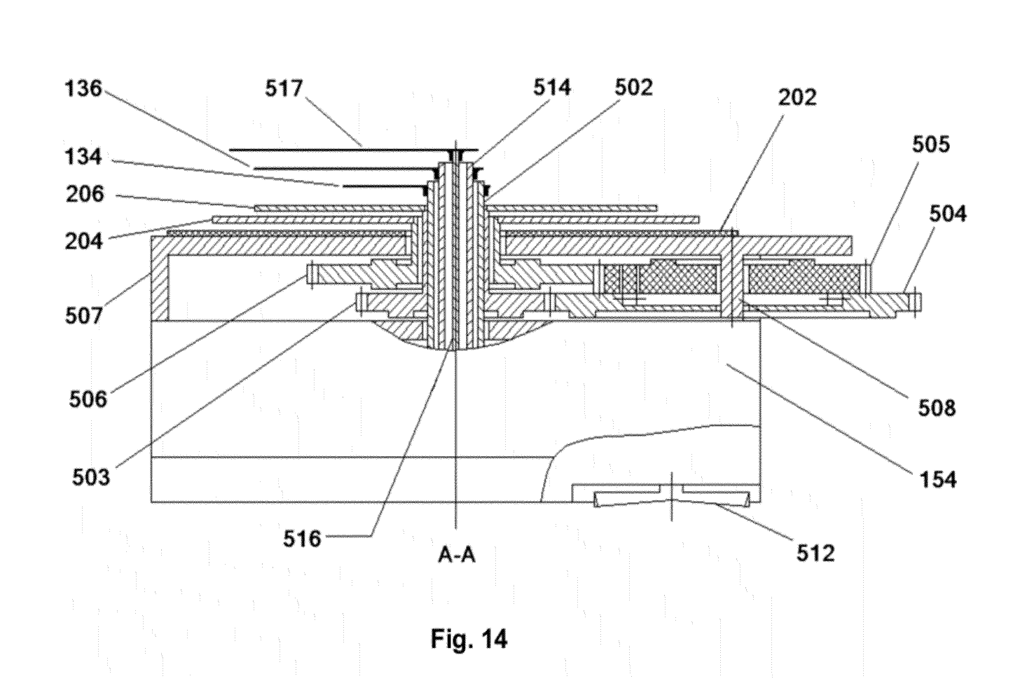

A universal quartz clock movement 154 (with a three-pointer timing system according to the 12-hour system) which is well-known by technical personnel in this field is selected. However, in order to meet the requirement of the example, the length of output axes of the three pointers (502, 514, 516) need to be long enough so as to meet the requirements of components of the additional wheel train which will be described below. 12-hour dial 202, the hour hand 134, the minute hand 136 and the second hand 517 which are matched with the universal quartz clock movement 154 are reserved to use as shown in FIG. 14. A set of transmission mechanism (for example a gear transmission mechanism) is arranged additionally outside the end surface of the output axis side of the movement. In the example, the additional wheel train is selected as an example of the gear transmission mechanism. As shown in FIG. 5, the additional wheel train comprises a synchronous wheel tube 503, a ratchet gear 504, a pawl wheel 505 and a last-stage half-speed wheel tube 506.

Besides the additional wheel train, an indicating mechanism is also additionally arranged. The indicating mechanism comprises a synchronous dial (as shown in FIG. 6 and FIG. 14) serving as a rotatable time zone dial 206 (certainly, it is understandable that the synchronous time zone dial can be used to replace the traditional hour hand 134) and a half-speed dial (as shown in FIG. 7 and FIG. 14) serving as a rotatable 24-hour marking dial 204. The relationship between the two dials and the arraying of markings on the dial surfaces are in accordance with the following rules.

a) The time zone dial 206 serves as the time zone scale and there are 24 time zone markings (meeting international standards) in total. A plurality of hour hand-shaped parts exerting the function of the hour hand indicating local time of a plurality of time zones (for example, 24 hour hand-shaped parts shown in FIG. 6 at the periphery are respectively used for indicating time of the 24 time zones) or hour hand-shaped marks are arranged on the rotatable time zone marking dial. The time zone markings are arrayed from west to east with South Pole as the viewing point (as shown in FIG. 6). It is understandable that the number of the time zones markings of the time zone dial can be adjusted according to the number of the time zones in need of displaying local time; for example, the number of the time zones can be reduced if the local time of the 24 time zones does not need to be fully displayed.

b) The half-speed dial 204 serves as the rotatable 24-hour marking dial and there are the 24 hour markings (namely the numerals 0 to 23) in total. The hour markings are arranged increasing by degrees (as shown in FIG. 7). The number of the hour markings can also be adjusted as required; for example, some hour markings can be omitted and only one part of hour markings are displayed. For another example, under the condition that the 24-hour system is adopted, only 0 and even numbers in the hour markings 0 to 23 are displayed or only the hour markings 0, 3, 6, 9, 12, 15, 18 and 21 are displayed.

The universal movement 154 adopted by the example comprises an energy mechanism, a time reference and a time travelling mechanism and is used for driving the additional wheel train.

The components comprised in the additional wheel train are described below.

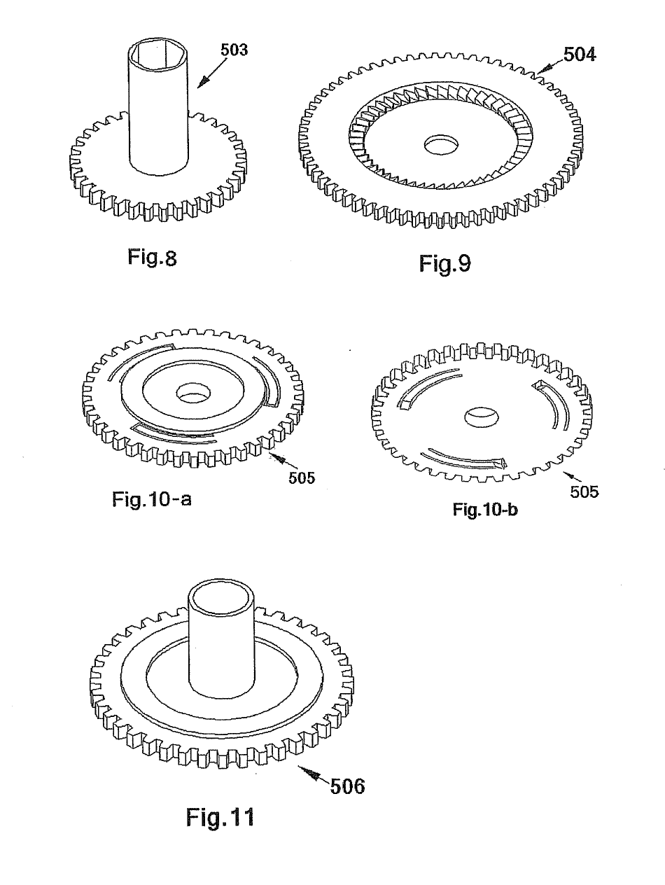

The section of the contact part between an inner hole of the synchronous wheel tube 503 (as shown in FIG. 8) and the axis tube of the hour wheel 502 is a regular polygon, and the diameter of the inscribed circle of the regular polygon is slightly smaller than the outside diameter of the axis tube of the hour wheel 502 to form friction matching. The hour wheel 502 which is a component of the original movement is used for driving not only the hour hand but also the additional wheel train. Through friction matching of the axis tube, the synchronous wheel tube 503 is driven synchronously by the hour wheel 502 in a bidirectional way; in addition, the synchronous wheel tube 503 drives the ratchet gear 504 with a speed ratio of 2:1 through occlusion between the wheel teeth of the synchronous wheel tube 503 and the gear teeth of the ratchet gear 504.

When the synchronous wheel tube 503 is forced by an external force to rotate counterclockwise and both the inner wall of the synchronous wheel tube 503 and the outer wall of the axis tube of the hour wheel 502 slide to stop reverse transmission.

A central hole of the time zone dial 206 is matched closely with the outer diameter of the synchronous wheel tube 503; when in assembling, the time zone dial 206 is sheathed fixedly at the upper end of the synchronous wheel tube 503 so that the time zone dial 206 can be driven by the synchronous wheel tube 503 to rotate synchronously with the synchronous wheel tube 503.

The ratchet gear 504 (as shown in FIG. 5 and FIG. 9) and the pawl wheel 505 jointly form a unidirectional transmission device which synchronously drives the pawl wheel 505 clockwise. The number of outer teeth of the ratchet gear 504 is 68 and the number of outer teeth of the pawl wheel 505 (as shown in FIG. 10) is 40. The ratchet gear 504 and the pawl wheel 505 are coaxially assembled through the matching between the ratchet teeth and the pawl to form a ratchet group which can carry out counterclockwise transmission and has a speed ratio of 1:1 so as to drive the last-stage half-speed wheel tube 506. When an external force forces the ratchet gear 504 to rotate clockwise, the pawl of the pawl wheel 505 is pressed to be deformed to slide with the ratchet teeth of the ratchet gear 504 so as to stop the transmission; meanwhile, the ratchet gear 504 forces the synchronous wheel tube 503 to rotate counterclockwise so as to realize the function of regulating the system time. In other words, the pawl of the pawl wheel 505 is deformed when the ratchet gear 504 rotates clockwise and the pawl wheel 505 slides with the ratchet gear 504 so as to realize the function of time regulating.

The last-stage half-speed wheel tube 506 (as shown in FIG. 5 and FIG. 11) fixes and drives the 24-hour dial 204 and the number of teeth is 40; driven by the pawl wheel 505 with a speed ratio of 1:1 in a bidirectional way, the 24-hour dial 204 rotates synchronously with the last-stage half-speed wheel tube 506 through the close matching between the central hole of the 24-hour dial 204 and the outer diameter of the last-stage half-speed wheel tube 506. When in assembling, the 24-hour dial 204 is sheathed fixedly at the upper end of the last-stage half-speed wheel tube 506. In the example, half speed of the half-speed wheel tube 506 is spoken relative to the synchronous wheel tube 503 or the hour wheel 502, namely the rotation speed of the half-speed wheel tube 506 is half of that of the synchronous wheel tube 503 or the hour wheel 502 so as to realize that the rotation speed of the rotatable time zone dial is the same as that of the synchronous wheel tube 503 or the hour wheel 502 while the rotation speed of the rotatable hour marking dial is half of that of the rotatable time zone dial.

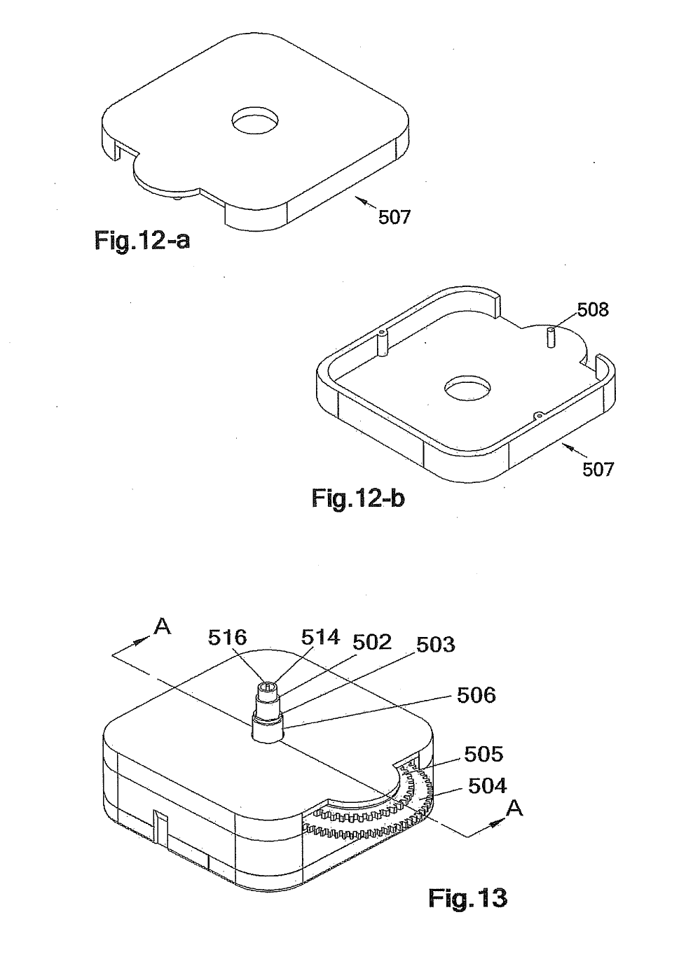

An additional end cover 507 can also be additionally arranged. The additional end cover 507 (as shown in FIG. 12-a and FIG. 12-b) is used for positioning, installing and protecting the additional wheel train. An axis output hole, a ratchet installing and positioning column 508 and two screw holes (as shown in FIG. 12-b) are arranged on the additional end cover 507. As a dependent component, the positioning column 508 is one part of the additional end cover 507 and plays a role of supporting and positioning. Of course, when no additional end cover 507 is arranged, a shell of the universal movement can be changed to cover the additional wheel train. The 12-hour dial 202 arranged fixedly on the outer end surface of the additional end cover 507 is provided with hour markings of the 12-hour system according to 12-indexing, which is the same as the 12-indexing fixed dial of the traditional clock. It is understandable that the improved end cover of the shell can exert the functions of positioning, installing and protecting the additional wheel train and the additional end cover is allowed not to be arranged if the shell with the end cover of the original movement is improved and the additional wheel train is arranged at the inner side of the end cover of the shell of the traditional movement.

The universal movement has the function of utilizing a regulating button 512 to regulate time. The hour hand 134 not only has the original function of the universal movement but also can be used for indicating hour markings of the 24-hour system. The minute wheel 514, the minute hand 136, the second axis 16 and the second hand 517 all implement the original function of the universal movement and no more details will be given below.

The assembling method of the time display device of the example is described below.

The assembling steps of the additional wheel train are as follows:

With the wheel part below and the pipe part above, the synchronous wheel tube 503 is sheathed at the tube part of the hour wheel 502 and is in friction matching with the hour wheel 502 so as to realize synchronous rotation; with the gear part below and the axis tube part above, the half-speed wheel tube 506 is sheathed on the synchronous wheel tube 503 and can slide relative to the synchronous wheel tube 503; with the ratchet gear 504 below and the pawl wheel 505 above, the ratchet teeth of the ratchet gear 504 are relatively matched with the pawl of the pawl wheel 505 to form a ratchet mechanism; the positioning column 508 of the additional end cover 507 penetrates through a concentric axis hole earlier than the pawl wheel 505 and later than the ratchet gear 504; the output axis of the movement 154 on which the synchronous wheel tube 503 and the half-speed wheel tube 506 are sheathed penetrates through an output hole of the additional end cover 507; fine position adjusting is carried out to realize occlusion between the wheel teeth of the synchronous wheel tube 503 and the gear teeth of the ratchet gear 504, elastic press fit between the ratchet teeth of the ratchet gear 504 and the pawl of the pawl wheel 505 and occlusion between the wheel teeth of the pawl wheel 505 and the wheel teeth of the half-speed wheel tube 506; and the movement 154 and the additional end cover 507 are locked into a whole by screws to form a composite movement with the function of a dual-time system (as shown in FIG. 13).

The ratchet gear 504 is exposed so as to be convenient for setting and regulating the clock.

The assembling steps of the indicating mechanism (as the basis of the example, the composite movement is matched with indicating mechanisms with different sizes and can be manufactured into a wristwatch, a small wall clock, a large wall clock or a desk clock) are as follows:

The 12-hour dial 202 is fixed at the outer side of the additional end cover 507 of the composite movement and the hour marking “12” is located at the center position of the upper part, so that the 12-hour dial 202 has no difference from the dial of a universal clock; the 24-hour dial 204 is arranged on the last-stage half-speed wheel tube 506, with any hour marking value aiming at any hour marking on the 12-hour dial 202; with the time zone marking of any time (o'clock) zone aiming at certain hour marking of the 12-hour dial 202, the time zone dial 206 is arranged on the synchronous wheel tube 503; the hour hand 134 is arranged at the upper end of the tube part of the hour wheel 502, aiming at any hour marking (for example 4) of the 12-hour dial 202. The minute hand 136 and the second hand 517 are respectively arranged at the front ends of the minute axis of the minute wheel 514 and the second axis, aiming at the hour marking “12” of the 12-hour dial 202.

As shown in FIG. 14, after the indicating mechanism is assembled on the composite movement, a principle sectional view for the whole structure of the analog world time quartz clock adopting the dual-time system is obtained through the sectioning along the position A-A in FIG. 13.

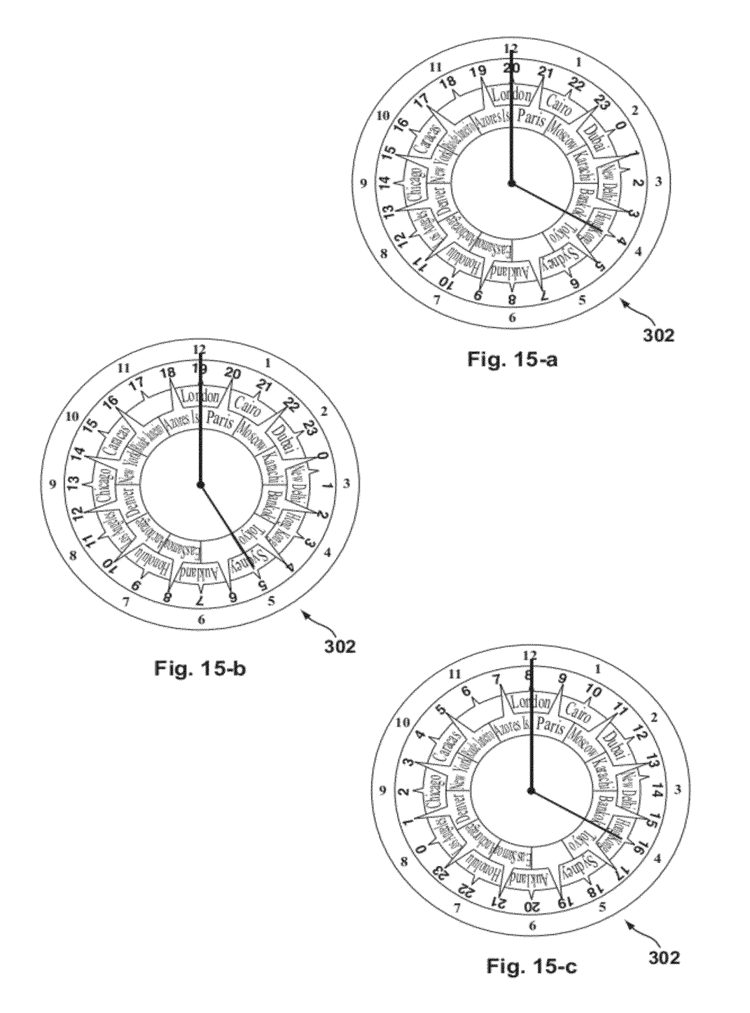

FIG. 15-a shows the effect after the indicating mechanism is assembled.

The working process of Example 1 of the invention is as follows: the hour wheel 502 exerts the function of an hour axis to form a power (namely time scale torque) output component, the power output component is used for outputting and transmitting the time scale torque of the movement to the additionally-arranged transmission mechanism, and then the additionally-arranged transmission mechanism transmits the time scale torque to the rotatable hour marking dial and the rotatable time zone dial. The specific driving process namely the driving process of the additional wheel train is as follows: after the whole clock is powered up, the timing function of the original universal movement is as usual, a new indicating system is formed during running of the time zone dial 206, the rotatable 24-hour marking dial 204 and the hour hand 134.

The driving process is as follows:

TABLE 1

| Driving wheel | | Description of the transmission | | | Driven wheel | | |
|---|---|---|---|---|---|---|---|
| Name of | Rotating | | | Speed | Name of | Rotating | Realized functions of |
| component | direction | Type | Feature | ratio | component | direction | transmission and indication |
| Hour wheel | Clockwise | Friction | Overload | 1:1 | Synchronous | Clockwise | The hour hand and the time zone |
| 502 | | | sliding | | wheel tube | | dial rotate synchronously with |
| | | | | | 503 | | the period of 360°/12 h. |
| Synchronous | Clockwise | Gear | Reliable | 2:1 | Ratchet gear | Counter- | The torque is transmitted and the |
| wheel tube | | | transmission | | 504 | clockwise | rotating period is changed |
| 503 | | | | | | | into 360°/24 h. |
| Ratchet gear | Counter- | Ratchet | Unidirectional | 1:1 | Pawl wheel | Counter- | The torque continues to be |
| 504 | clockwise | | transmission | | 505 | clockwise | transmitted. |
| Pawl wheel | Counter- | Gear | Reliable | 1:1 | Half-speed | Clockwise | The 24-hour marking dial rotates |
| 505 | clockwise | | transmission | | wheel tube | | according to the period |
| | | | | | 506 | | of 360°/24 h. |

Hereinafter described are the setting and regulating of the clock.

Setting of a main time zone (with Hong Kong as the using place): the regulating button 512 is manually rotated clockwise and components of an indicating system are rotated clockwise according to respective rotation speed; certain hour marking of a 24-hour dial 204 is set to aim at a corresponding hour marking of the 12-hour dial 202, for example 4 or 16 aims at 4, 6 or 18 aims at 6 and 11 or 23 aims at 11; finally, the ratchet gear 504 is manually poked clockwise to realize that the time zone marking “Hong Kong” on the time zone dial 206 is overlapped with the hour hand. Setting of time of the time zones (time regulating for the first time): the regulating 512 is manually rotated counterclockwise; besides the last-stage rotatable 24-hour dial 204, the time zone dial 206, the hour hand and the minute hour hand are respectively rotated counterclockwise. The regulating result needs to meet that the hour hand and minute hour hand indicate time of the main time zone according to the 12-hour system and meanwhile the time zone marking “Hong Kong” and the hour hand jointly indicate time of the last-stage rotary 24-hour dial 204 according to the 24-hour system. See the effect shown in FIG. 15.

Fine adjusting of the system (time check-up): when the time indicated is later than the correct one, the regulating button 512 is manually rotated clockwise (the same as the time regulating of the universal clock); when the time indicated is earlier than the correct one, a battery is removed to stop the running of the clock and fine adjusting is carried out after the time indicated is later than the correct one.

The application range of the example: the additional wheel train and the dials are only arranged at the outer side of the output axis of the movement in the example, so that the example is suitable for not only the quartz clock but also a mechanical clock. Such final product forms as a small wall clock, a desk clock, a large/medium wall clock (like an outdoor/indoor building clock) can all be implemented.

In order to meet some personalized requirements, the classical clock/watch mechanism rotates counterclockwise in the previous design and the hour markings are arrayed decreasing by degrees. Such design is an image duplication of the prototype in essence. Similarly, the example can also be manufactured into an imaging device of which rotary components rotate counterclockwise and the arraying order of markings is also reverse. The practical application of the imaging device is as follows: a special clock/watch is manufactured to meet some personalized requirements; the display device of the original clock is enlarged and transparent materials are adopted to manufacture an integrated dual-face clock with a transparent dial. In order for bidirectional identification, such patterns as national flags, landmarks, etc can be selected as time zone markings and hour markings can also be correspondingly screened or designed. Such dual-face clock not only has complete displaying function but also achieves unique visual effect.

The time zone dial of the example is designed according to international standard time zones so as to adapt to general requirements. If only aiming at the requirements of several specific time zones, the time zone dial can be simplified into a time zone dial with multiple time zones and the mechanical structure is kept unchanged. The method is that the sequence relationships among the time zones (including those hidden ones) are kept unchanged and the non-selected time zone markings are hidden (see Example 2).

### Example 2

Example 2 is an analog phase hour marking clock with multiple time zones and adopting the 24-hour system.

The system composition of the example is consistent with the analog world time quartz clock adopting the dual-time system in Example 1. The differences lie in that 1) the global standard 24 time zones of the rotatable time zone dial are replaced by multiple time zones; 2) the hour markings of the 24-hour marking dial are provided with phase positions; 3) the display mechanism adopting the 12-hour system is simplified. Details will be given below.

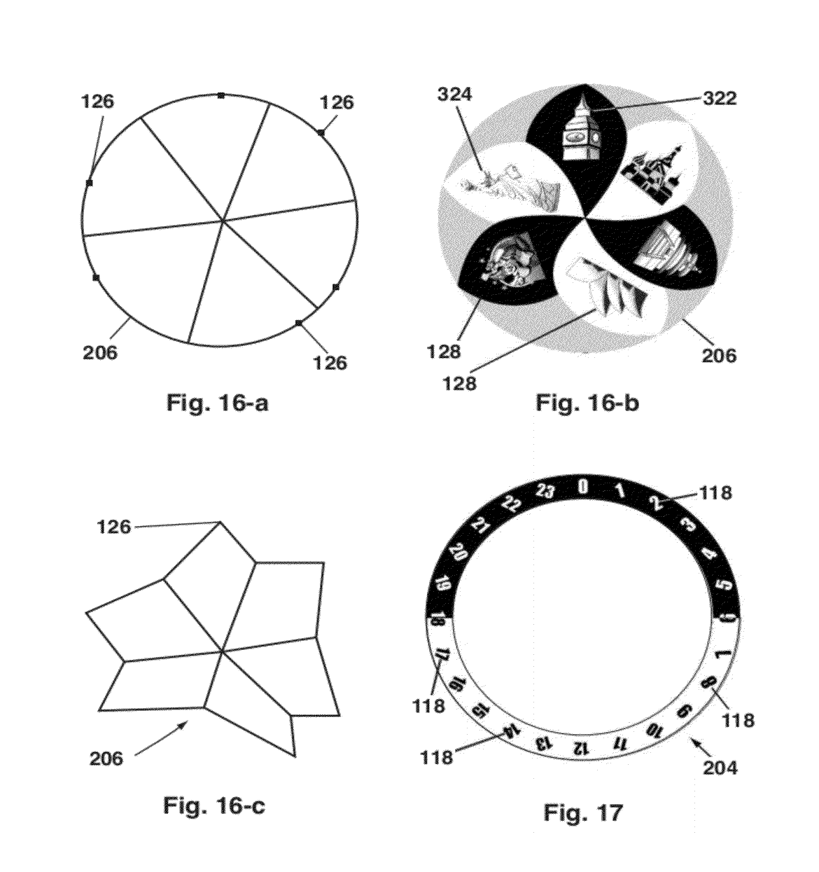

1. Multiple time zones of the time zone dial: 1) time zones are selected: a) a plurality of time zones (for example 6 time zones) are selected according to the requirement; b) landmark patterns in famous cities of the time zones are selected as time zone markings (see Table 3) and the rest 18 time zones are hidden; c) the order relationships among the time zones (including the hidden ones) are kept unchanged. 2) the time zone markings are highlighted: a) a blank zone is realized on the dial surface due to the hiding of 18 time zones so that 6 time zone markings can be highlighted; b) the position of the time zone marking of each time zone is expanded right and left so that 6 fan-shaped zones connected with one another are presented on the dial (see FIG. 16-a); c) 6 scale positions at the rim of the dial are adopted as top points and the boundary line of each fan-shaped zone is properly shrunk inwards (arcs at the two sides of each top point are then pulled towards the center of the circle); in order to beautify the visual effect, a curved area drawing is adopted; the time zone markings are filled up according to the time zone positions, and FIG. 16-b shows the time zone dial of a clock with 6 time zones; d) the shape of the dial can be changed into a star according to the profile of the zone (see FIG. 16-c); if the time zones can be chosen uniformly, the profile of the zone can present the shape of a regular polygon or a regular star. By contrast, FIG. 16-c lacks sense of beauty and is therefore allowed not to be adopted.

2. The hour markings of the 24-hour system are provided with phase positions (taken Arabic numerals as an example): 1) an hour marking ring is divided into a day section (the numerals 6 to 18 are black in a white background) and a night section (the numerals 18 to 6 are white in a black background); 2) determination of the phase positions of the hour markings: a) the scale for the hour marking “0” is positioned at the highest point of the dial and the positions of other hour markings are determined accordingly; b) the phase position of every hour marking (see Table 2) can be determined according to −15°×G (G represents the numerals 0 to 23 of the hour markings); The design result is shown in FIG. 17.

TABLE 2

| hour marking | 0 | 1 | 2 | 3 | 4 | 5 | 6 | 7 |
|---|---|---|---|---|---|---|---|---|
| Phase position | 0° | −15° | −30° | −45° | −60° | −75° | −90° | −105° |
| hour marking | 8 | 9 | 10 | 11 | 12 | 13 | 14 | 15 |
| Phase position | −120° | −135° | −150° | −165° | 180° | −195° | −210° | −225° |
| hour marking | 16 | 17 | 18 | 19 | 20 | 21 | 22 | 23 |
| Phase position | −240° | −255° | −270° | −285° | −300° | −315° | −330° | −345° |

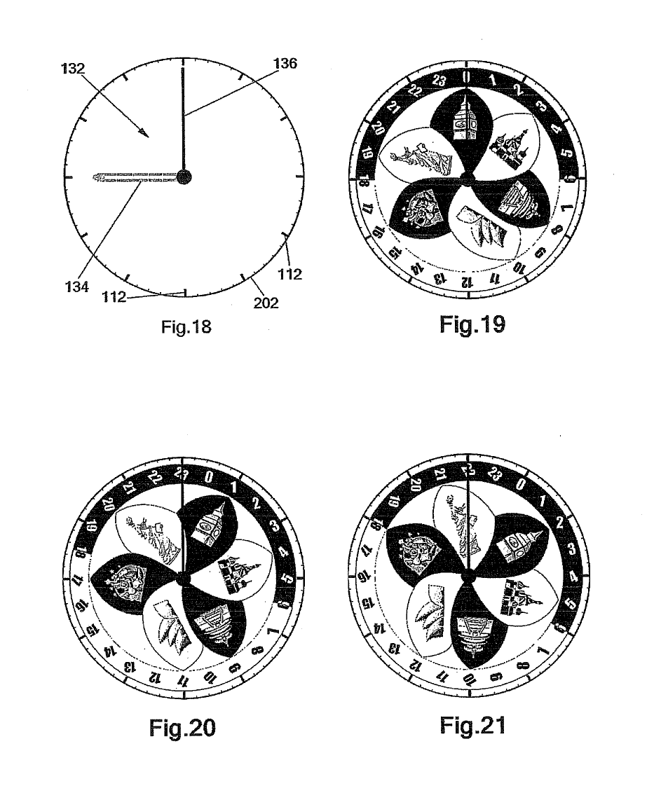

3. Simplification of the classical display mechanism (see FIG. 18): 1) 12-indexing scales of the dial are retained and the hour markings 1 to 12 are deleted; 2) the minute hour hand is retained and the hour hand is deleted. (The hour hand is an important display component. When the invention is implemented, the role of the hour hand is diminishing as the position of the hour hand is the same as that of the time zone marking of the main time zone; in this case, the hour hand is omitted in the example. As shown in FIG. 18, the gray dotted line just shows the case.)

The assembling of the time display device in the example: 1) the assembling of the additional wheel train is consistent with that of Example 1; 2) refer to the assembling way of Example 1 to learn about the assembling of the indicating mechanism, wherein a) as the 12-hour dial is not provided with hour markings, the dial only needs to be well placed (one of the highlighted scales in FIG. 18 is placed at the position of 12 o'clock); b) the hour hand is omitted; c) the hour marking 0 of the 24-hour dial 204 is placed at the position of 12 o'clock.

The running effect of the time display device of the example is as follows: 1) London is adopted as the main time zone and the time zone marking is the landmark “Big Ben”; as shown in FIG. 19, the time of London starts from 0 o'clock; 2) as shown in FIG. 20 to FIG. 24, the time of London starts from 1 o'clock to 4 o'clock; when at o'clock time, the hour markings pointed by “Big Ben” are all upright; the numerals and positions of those hour markings are consistent with the classical dial adopting the 12-hour system, and other hour markings all have respective angles; the time of London in FIG. 23 is 3:40, the “Big Ben” points at the position between the hour markings 3 and 4 while the minute hand points at the scale of 40 minutes; and the hour marking 4 is almost upright and close to the position of the classical dial adopting the 12-hour system; 3) FIG. 25 to FIG. 28 show four o'clock time pm of London; the “Big Ben” points at the corresponding hour markings of the 24-hour system at the traditional position and only those hour markings are upright; 4) The zone time of each time zone in the 24-hour system is displayed in following Table 3. If the using place is changed, another main time zone can be set according to Item 1) described above.

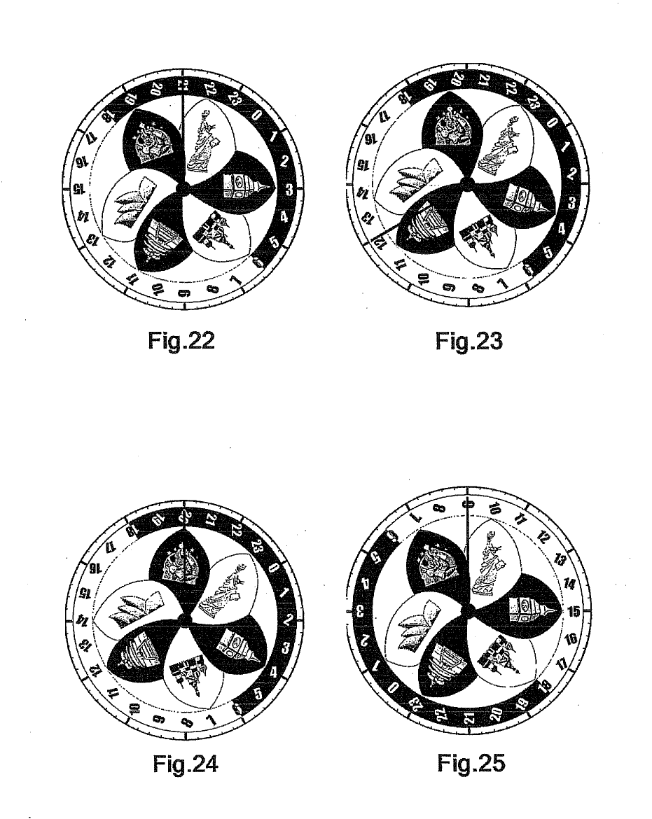

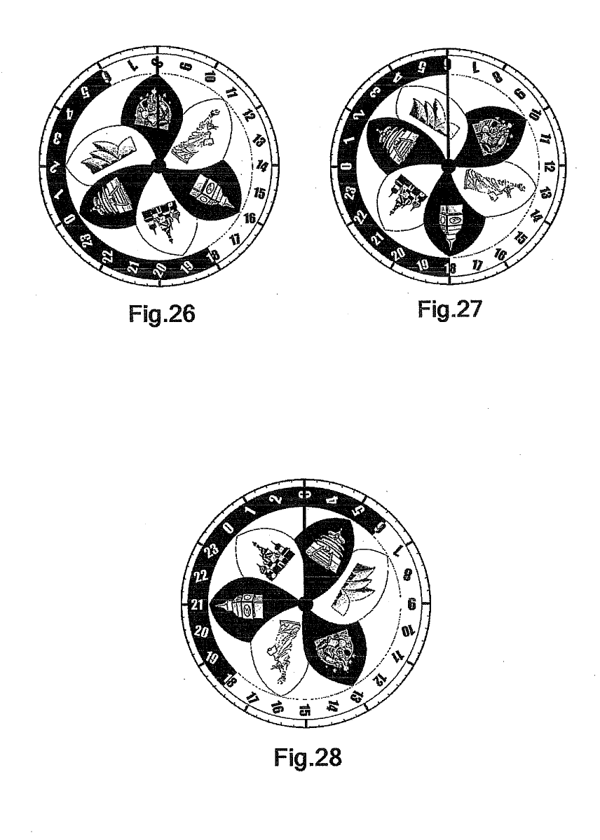

TABLE 3

| GMT | | | | | | | Time zone |
|---|---|---|---|---|---|---|---|
| (Main time zone) | | | GMT + 8 | | | | Representative |
| Position | | GMT + 3 | Beijing | GMT + 10 | | GMT − 5 | City |
| of 12- | | Moscow | The Hall of | Sydney | GMT − 8 | New York | Landmark |
| hour | London | St Isaac's | Prayer for | Opera | Los Angeles | Statue of | pattern of |
| markings | Big Ben | Cathedral | Good Harvest | House | Disney | Liberty | time zone |
| 12 | 0:00 | 3:00 | 8:00 | 10:00 | 16:00 | 19:00 | FIG. 19 |
| 1 | 1:00 | 4:00 | 9:00 | 11:00 | 17:00 | 20:00 | FIG. 20 |
| 2 | 2:00 | 5:00 | 10:00 | 12:00 | 18:00 | 21:00 | FIG. 21 |
| 3 | 3:00 | 6:00 | 11:00 | 13:00 | 19:00 | 22:00 | FIG. 22 |
| 3 to 4 | 3:40 | 6:40 | 11:40 | 13:40 | 19:40 | 22:40 | FIG. 23 |
| 4 | 4:00 | 7:00 | 12:00 | 14:00 | 20:00 | 23:00 | FIG. 24 |
| 3 | 15:00 | 18:00 | 23:00 | 1:00 | 7:00 | 10:00 | FIG. 25 |
| 4 | 16:00 | 19:00 | 0:00 | 2:00 | 8:00 | 11:00 | FIG. 26 |
| 6 | 18:00 | 21:00 | 2:00 | 4:00 | 10:00 | 14:00 | FIG. 27 |
| 9 | 21:00 | 0:00 | 5:00 | 7:00 | 14:00 | 17:00 | FIG. 28 |

The application range of the time display device is as follows: 1) people usually are only interested in a plurality of time zones due to non-uniform distribution of the large world population, difference of development level and diversity of social life; according to the example, specific time zones are selected for combination and the time zone dial with a plurality of time zones is customized, namely a clock with a plurality of times zones can be manufactured to meet various requirements; and even a highly-personalized product can be manufactured; 2) although no hour hand is arranged, the indication for time of the main time zone according to the dual-time system and the indication for time of the selected time zones according to the 24-hour system are quite clear. The time display device of the example has both strong practicability and high novelty.

Examples described in the description or the technical schemes of the invention can have various variations. For example, the time display device is not limited to a three-hand timing system and the second hand or the hour hand or both the hour hand and the second hour hand can be cancelled. In addition, according to variations of the examples of the invention, a traditional hour hand can be used to replace the rotatable time zone dial so that the time display device can be simplified into the one with the dual-time systems. Moreover, the time display device of the invention is not limited to the quartz clock/watch or the mechanical clock/watch. Time can also be displayed on various electronic screens according to the principle of the invention. The rotatable time zone dial with a rotation period of 360°/12 h and the rotatable hour marking dial with a rotation period of 360°/24 h can be displayed on the electronic screen through a program in an analog way. The number of teeth of the gear and the ratchet gear and the number of pawls of the pawl wheel comprised in the time display device of the example can all be adjusted according to specific requirements of the design. Example 1 provide a specific additional wheel train. However, technical personnel in this field can think of and design many kinds of additional wheel trains according to the requirement on the basis that the description of the invention is disclosed, the number of gears of the designed additional wheel trains can be different from that of Examples 1 (namely the number can be either increased or reduced), and the number of teeth of every gear can also be adjusted. All those variations of the technical schemes which satisfy the condition that the rotatable time zone dial rotates synchronously with the rotatable hour marking dial in the same direction and the rotation speed of the rotatable time zone dial is twice of that of the rotatable hour marking dial can realize the purpose of the invention. And all those variations are included in the scope of the invention. The time display device of the invention can be designed to adopt an image structure namely all indicating mechanisms and indicating components such as all the rotatable dials, the hour hand, the minute hand and the second hand rotate not clockwise but counterclockwise.

Various examples of the invention have now been described in detail. Those skilled in the art will appreciate that numerous modifications, adaptations and variations may be made to the examples. Therefore, the invention is not to be limited to those details but only by the appended claims.

What is claimed is:

1. A time display device comprising:
a first time display component for showing first time markings of a system having a first number of hours in a day on a first time scale;
a second time display component for showing second time markings of a system having a second number of hours in a day on a second time scale;
a time zone display component including a time zone display, said time zone display including time zone markings to indicate time zones in a pre-defined time zone system, the total number of whole hour time zones in the pre-defined time zone system being the same as the second number of hours;
a time indication component for positioning a time indicator to indicate time on said first time scale according to a time source;
said time indicator and said time zone display advancing relative to the first time scale both at a first speed and in the same direction, said second time scale advancing relative to said first time scale at a second speed and in the same direction as the time indicator, a ratio of said second speed to said first speed being equal to a ratio of the first number of hours to the second number of hours; and
wherein said second time scale is resettable to align any one of the second time markings with any one of the first time markings at a time reset time and the time zone display is resettable to align any one of the time zone marking with any one of the second time markings of the second time scale at a time zone reset time.

2. The time display device of claim 1, wherein the number of time zone markings is less than or equal to the total number of whole hour time zones.

3. The time display device of claim 1, wherein the first time display component includes a 12-hour circular member for displaying said first time scale, said first time scale having indicated thereon the first time markings representing each of 12 hours in a 12-hour system and said second time display component includes a 24-hour circular member for displaying said second time scale, said second time scale having indicated thereon the second time markings representing each of 24 hours in a 24-hour system, said 12-hour circular member and the 24-hour circular member being concentric and the ratio being 1:2.

4. The time display device of claim 3 wherein the time indicator includes an hour indicator to indicate the hour readings on both the 12-hour circular member and the 24-hour circular member.

5. The time display device of claim 4 further comprising the time source.

6. The time display device of claim 5 wherein the time source is one of mechanical movement, electrical quartz movement, and electronic clock circuitry.

7. The time display device of claim 1, wherein the time display device further includes a casing and the first time scale is static relative to the casing.

8. The time display device of claim 7, further comprising a first time dial to show the first time scale, a second time dial to show the second time scale, and a time zone dial to show the time zone display thereon, wherein said first time dial, said second time dial, said time zone dial are arranged adjacent to and spaced from each other to permit simultaneous reading of said first time markings, said second time markings and said time zone markings.

9. The time display device of claim 8, wherein each of said second time markings includes an hour marking and a corresponding marking of phase position.

10. The time display device of claim 8, further comprising a casing,
wherein said time indication component further comprises an hour axis mounted inside said casing, said time indicator being an hour hand fixedly mounted to and rotated by said hour axis at the first speed; and
wherein said first time dial is a first circular plate having a first diameter, said second time dial is a second circular plate having a second diameter unequal to the first diameter, and said time zone plate is a third circular plate having a third diameter unequal to either of the first diameter and the second diameter, said third circular plate being concentrically and rotatably mounted to or being synchronously driven by said hour axis and rotating at the first speed;
said first circular plate being fixedly mounted relative to the casing and concentric about the hour axis,
said second circular plate being mounted inside said casing and concentric about said hour axis, said second circular plate rotating at the second speed.

11. The time display device of claim 10, further comprising:
an hour advance mechanism connected to said hour axis to rotate the hour axis at the first speed, the hour hand and the third circular plate being driven by the hour axis at the first speed;
a half-speed advance mechanism connected to said second time display component to advance said second circular plate at the second speed; and
said hour advance mechanism and said half-speed advance mechanism being coupled to the time source for establishing the first speed and the second speed.

12. The time display device of claim 11, wherein said half-speed advance mechanism being coupled to the time source through said hour advance mechanism.

13. The time display device of claim 12, wherein said hour advance mechanism comprises a first transmission train between said time source and said hour axis and said half-speed advance mechanism comprises a second transmission train between said hour advance mechanism and said second circular plate.

14. The time display device of claim 11, wherein said hour advance mechanism comprises a first motor configured to advance said hour axis according to said time source and said half-speed advance mechanism comprises a transmission train between said first motor and said second circular plate to advance said second circular plate.

15. The time display device of claim 7, further comprising a display screen, wherein the first time scale, the second time scale, the time zone display and the time indicator are shown on the display screen.

16. The time display device of claim 15, further comprising a microprocessor, said microprocessor controlling operation of the first time display component, the second time display component, the time zone display component, and the time indication component.

17. A method of displaying time, comprising the steps of:
initializing a display area, said display area comprising a first time display scale for showing first time markings of a system having a first number of hours in a day, a second time display scale for showing second time markings of a system having a second number of hours in a day, and a time zone display scale for showing time zone markings to indicate time zones in a pre-defined time zone system, the total number of whole hour time zones in the pre-defined time zone system being the same as the second number of hours,
obtaining a first time, said first time including at least a first hour value,
positioning a time indicator on said first time display scale according to the first hour value,
aligning the second time display scale with the first time display scale according to the first hour value,
aligning the time zone display scale with the second time display scale according to the first hour value and an input of a local time zone value,
in a loop until interrupted by an external instruction,
obtaining an updated time;
advancing the hour indicator on said first time display scale according to the updated time, said advancement establishing a first amount advanced by the hour indicator;
advancing the time zone display scale for the first amount;
advancing the second time display scale for a second amount, the second amount being equal to the first amount multiplied by the ratio of the first number of hours to the second number of hours; and
returning to the step of obtaining updated time.

18. The method of claim 17, further comprising the step of waiting for a first pre-selected period of time prior to returning.

19. The method of claim 17, further comprising the steps of testing between the step of obtaining the current time and advancing the hour indicator if a second pre-selected period of time has elapsed and returning to the step of obtaining updated time if the second pre-selected period of time has not elapsed.

20. The method of claim 17, wherein the number of time zone markings shown on the time zone display scale is less than or equal to the total number of whole hour time zones.

21. The method of claim 17 wherein the first time display scale includes a 12-hour circular member, said 12-hour circular member having indicated thereon marks representing each hour in a 12-hour system and said second time display scale has a 24-hour circular member, said 24-hour circular member having indicated thereon marks representing each hour in a 24-hour system, said 12-hour circular member and the 24-hour circular member being concentric.

22. The method of claim 21 wherein the hour indicator is an hour hand configured to indicate the hour readings on both the 12-hour circular member and the 24-hour circular member.

23. A non-transitory computer readable storage medium containing computer program instructions stored thereon, when executed by a processing system, causing the processing system to perform a method comprising steps of:
initializing a display area, said display area comprising a first time display scale for showing first time markings of a system having a first number of hours in a day, a second time display scale for showing second time markings of a system having a second number of hours in a day, and a time zone display scale for showing time zone markings to indicate time zones in a pre-defined time zone system, the total number of whole hour time zones in the predefined time zone system being the same as the second number of hours,
obtaining a first time, said first time including at least a first hour value,
positioning a time indicator on said first time display scale according to the first hour value,
aligning the second time display scale with the first time display scale according to the first hour value,
aligning the time zone display scale with the second time display scale according to the first hour value and an input of a local time zone value,
in a loop until interrupted by an external instruction,
obtaining an updated time;
advancing the hour indicator on said first time display scale according to the updated time, said advancement establishing a first amount advanced by the hour indicator;
advancing the time zone display scale for the first amount;
advancing the second time display scale for a second amount, the second amount being equal to the first amount multiplied by the ratio of the first number of hours to the second number of hours; and
returning to the step of obtaining updated time.

24. The non-transitory computer readable storage medium of claim 23, wherein the number of time zone markings shown on the time zone display scale is less than or equal to the total number of whole hour time zones.

25. The non-transitory computer readable storage medium of claim 23, wherein the first time display scale includes a 12-hour circular member, said 12-hour circular member having indicated thereon marks representing each hour in a 12-hour system and said second time display scale has a 24-hour circular member, said 24-hour circular member having indicated thereon marks representing each hour in a 24-hour system, said 12-hour circular member and the 24-hour circular member being concentric.
